(19) United States
(12) Patent Application Publication
(10) Pub. No.: US 2005/0033993 A1
(43) Pub. Date: Feb. 10, 2005

(54) Method of authorising a user

(76) Inventors: Calum Shepherd Cooper, Rye (GB); Francis Michael O'Dwyer, Ashford (GB)

Correspondence Address: FAEGRE & BENSON LLP;PATENT DOCKETING, 2200 WELLS FARGO CENTER, MINNEAPOLIS, MN, 55402, US

(21) Appl. No.: 10/834,304

(22) Filed: Apr. 28, 2004

(30) Foreign Application Priority Data
Apr. 29, 2003 (GB) GB 0309774.8

(51) Int. Cl. H04L 9/32

(52) U.S. Cl. 713/202

(57) ABSTRACT

A method of and apparatus for authorising a user is provided which can be used to allow a user to regain access to a computer system in circumstances where the user has forgotten his or her password. Two authorisers in the form of second and third users of the computer system provide authorisation information to a computer that indicates the identity of the authorisers and of the first user. The computer is operable to check the authorisation information against stored authorisation information to which it has access. This is done to ascertain whether or not the authorisers are allowed to authorise the first user. If the authorisers are allowed, the first user is authorised and is provided with access to the computer system.

The present application claims priority from United Kingdom Patent Application No. 0309774.8, filed on 29 Apr. 2003.

### INTRODUCTION AND BACKGROUND

This invention relates to a method of authorising a user. In particular, this invention relates to a method of authorising a user to access a computer system by resetting the user's password for accessing that computer system.

Users of computer systems are often each provided with a password for accessing those systems. The purpose of providing users with a password is to seek to eliminate access to such computer systems by one or more unauthorised persons. An example of the type of computer system that may be protected by user passwords is a computer network within a company and for access by employees of that company. In such a system, each employee who is to access the computer network would be provided with a respective username and a password for logging on to the network.

A user's username is usually derived from his or her real name and so is easy to remember. However, a user's password is usually chosen so as to be hard for another party to arrive at independently, for example by guessing, and so may be hard for the user to remember. In the event that a user forgets his or her password, he is prevented from accessing the computer system to which the forgotten password relates. A user must then usually contact a person staffing a computer “helpdesk” and either ask that person to remind him or her of the forgotten password, or to reset the password to either a widely-known standard password or to another password specific to the user. Reliance on helpdesks in such circumstances can lead to a delay in the user being able to gain access to the computer system if the helpdesk staff are busy, thus affecting the user's productivity; and can also cause helpdesk staffing levels to be greater that they might otherwise be. It has been suggested that many calls to helpdesks are related to forgotten passwords.

### SUMMARY OF THE INVENTION

It is an object of this invention to address the problem described above.

According to a first aspect of this invention there is provided a method of authorising a user, the method including the steps of:

a) computer means receiving authorisation information from at least two authorisers, that information being indicative that the user to is be authorised;

b) the computer means responding to receipt of the authorisation information by emitting an authorisation signal that authorises the user.

This is advantageous in that the user may be authorised by persons other than those staffing a computer helpdesk. For example, the user may be authorised by two of his colleagues, sitting nearby.

Step (b) may include the step of comparing the received authorisation information with stored authorisation information accessible by the computer means and that includes authorisation criteria, and providing the authorisation signal upon finding that the authorisation information meet the received authorisation criteria.

The method is, however, preferably for authorising a user to access at least part of a computer system, for example for authorising a user to access shared computer files, printers, email or to authorise a user such that a new computer account may be opened, an identity badge or a badge for admittance to a building is produced, or some such other record may be created for the user. It is envisaged, however, that the method may be for authorising a user to perform any action that is typically performed by a selected and privileged person within an organisation.

More preferably, this method is for authorising a user to access a computer system by resetting the user's password for accessing the computer system, wherein step (b) may include providing the authorisation signal such that the user's password is changed or the requirement for the user to give a password is at least temporarily removed. The authorisation signal may be provided to password changing means of the system. The password changing means may be arranged to communicate with authentication server means to change the password.

The authorisation information is preferably received from remote computer means operable by one or more of the authorisers to provide the authorisation information. The authorisation information may be provided over a computer network, such as a local area network; it may be provided over the Internet.

The received authorisation information may include authoriser information indicative of information relating to the authoriser from whom that authorisation information is received, and which may include one or more of the authoriser's username, credentials and domain within the computer system. The credentials may be in the form of a password. The password may include alphanumeric characters. The password may include and/or be based on and/or involve one or more of: biometrics, that is to say the physical attributes of the authoriser; Public Key Infrastructure; use of a smart card; one-time passwords; zero-knowledge proofs; and hand held authenticators.

Step (a) may be followed by the additional step of accessing stored authoriser information and comparing the received authoriser information therewith to establish whether or not the received authoriser information is acceptable, the authorisation signal only being provided if the received authoriser information is acceptable. The stored authoriser information may be indicative of authoriser criteria that must be satisfied in order for the authorisation signal to be provided, wherein this comparison may be by establishing whether or not at least some of the received authoriser information meets the authoriser criteria.

The received authorisation information may also include authorisee information indicative of information relating to the user who is to be authorised. The stored authoriser information may include information indicative of who may be authorised by the authoriser and step (a) may be followed by the step of accessing that information and comparing the received authorisee and/or authoriser information therewith to establish whether or not the user who is to be authorised may be so authorised by the authoriser, the authorisation signal only being provided in the event that this is the case.

The received authorisation information may include attestation information indicative of the circumstances of and/or surrounding the authorisation. The attestation information may include information indicative of, for example, whether or not: the user who is to be authorised is present; that user is personally known to the authoriser; that user personally requested authorisation from the authoriser; and the manner by which the authoriser identified the user when the request was made, such as by personal knowledge, company badge, telephone call. The method may include the step of storing some or all of the received authorisation information, preferably at least the attestation information, for later retrieval.

Storing the received authorisation information, and in particular the attestation information, is advantageous in that this constitutes an “audit trail” of information that may be examined in any dispute arising in relation to an authorisation made using the method, and that may be of use in resolving such a dispute.

Step (a) may be followed by the further step of accessing stored authorisee information indicative of information relating to the user who is to be authorised, that information being indicative of authorisee criteria that must be satisfied in order for the authorisation signal to be provided. For example, the stored authorisee information may be indicative of one or more of: who may authorise the user; by how many authorisers the user must be authorised for the authorisation signal to be provided; and the circumstance in which the user may be authorised, such as the times of day at which the user may be authorised, and the source address of the authoriser's session. Step (a) may also be followed by the step of comparing the received authorisation information with the stored authorisee information and establishing whether or not the criteria are satisfied, the authorisation signal only being provided in the event that this is the case.

If the criteria are satisfied, the method includes the step of recording that the user who is to be authorised has been authorised by the respective authoriser.

The method may then include the step of repeating at least some of the previously-defined steps for another authoriser and optionally for one or more further authorisers, until the user has been authorised by at least the number of authorisers specified by the stored authorisee information, whereupon the authorisation signal may be provided in step (b).

According to another aspect of this invention there is provided a computer program including code portions which when executed by computer means, cause those computer means to carry out the method of the first aspect of this invention.

According to a further aspect of this invention, there is provided a record carrying having the computer programme of the other aspect recorded thereon.

According to a still further aspect of this invention, there is provided a computer programmed to carry out the method of the first aspect of this invention.

According to a yet still further aspect of this invention, there is provided a computer system having a plurality of users and arranged such that at least one user can be authorised to gain access to the system by two other users providing authorisation information to the system.

Features of the other aspects of this invention may be features of this yet still further aspect of the invention, it being appreciated that changes in the terminology of those features may required for consistency with this aspect.

### BRIEF DESCRIPTION OF THE DRAWINGS

FIG. 1 shows, in schematic form, apparatus for use in carrying an embodiment of the invention;

FIG. 2 is a block diagram of components of a computer program; and

FIG. 3 is a flow chart of a method embodying this invention.

### EXEMPLARY DESCRIPTION OF PREFERRED EMBODIMENTS

Specific embodiments of this invention are now described by way of example only and with reference to the accompanying drawings.

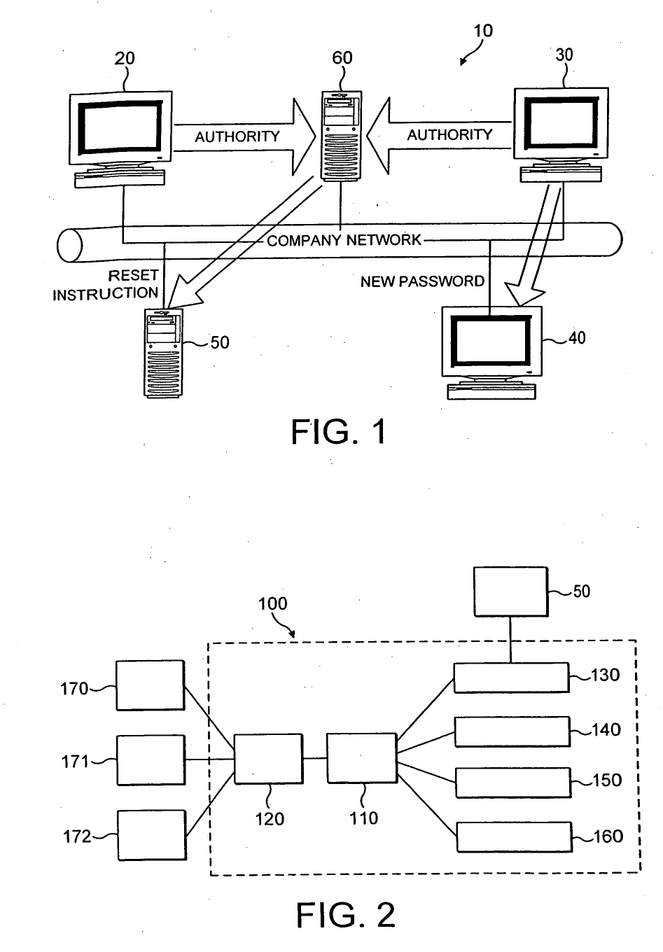

FIG. 1 shows apparatus 10 comprising a first computer terminal 20, a second computer terminal 30, a third computer terminal 40, a first computer server 50 and a second computer server 60. The computer terminals 20,30,40 and are connected to the first and second servers 50,60 so as to form a computer network with each of the terminals 20,30,40 arranged for communication with each of the servers 50,60 and each server 50,60 arranged for communication with the respective other server 50,60. The first server 50 is arranged to operate as an authentication server 50 and as such includes username and password information for users of the network. The second server 60 is arranged to operate as an application server that carries out a method that embodies this invention. Taken together, and together with software running thereon, the apparatus 10 constitutes a computer system that also embodies this invention.

The application server 60 carries out the method by running a computer program having component parts as shown in FIG. 2. With reference to FIG. 2, the computer program 100 includes a central process engine 110 arranged for coordinating activities between other components of the program 100. The other components are made up of a user interface server 120, an authentication system driver 130, authorisation policies 140, reset policies 150 and password policies 160.

Of these components, the user server interface 120 is arranged to provide an interface between the process engine 11O and users of the method. Three users are shown at 170, 171 and 172 in FIG. 2. The authentication system driver 130 is arranged to provide an interface between the process engine 110 and the authentication server 50.

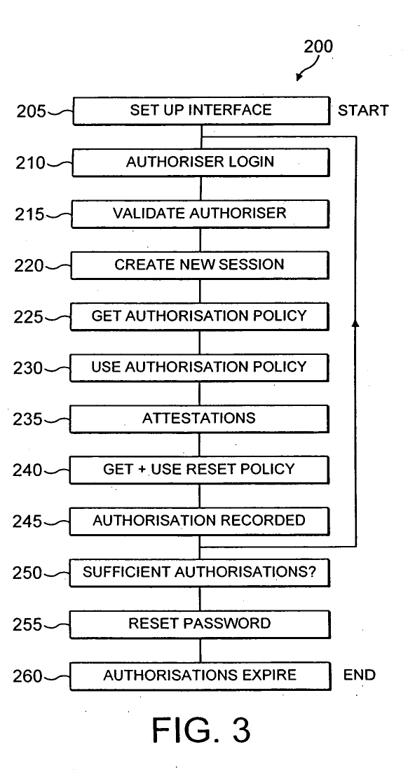

The method of the present embodiment finds use in circumstances where a user of the computer system has forgotten his or her password for accessing the system. The steps of this method are described with reference to FIG. 3.

FIG. 3 shows steps carried out by the application server 60 in carrying out the method 200 of this embodiment. The steps are initiated by the process engine 110. In a first step, which is shown as block 205 in FIG. 3, the user interface server 120 sets up an interface for interaction between the process engine 110 on a computer terminal of a first user of the method. The first user is termed a first “authoriser”. The terminal of the first authoriser is shown at 170 in FIG. 2. With continued reference to FIG. 3, the user interface server 205 sets up the interface with the authoriser by rendering web pages which are downloadable and completable by the authoriser, using his terminal 170.

The next step is shown at block 210. Here, the authoriser submits his login information, which is received via the user interface server 120. It is envisaged that the login information received would be the authoriser's username, his credentials in the form of a password, and the desired domain of the computer system.

At block 215, the authentication system driver 130 communicates with the authentication server 50 to ascertain whether the password entered by the authoriser is valid for that user for the selected domain. If the password is valid, the method proceeds to the following step at block 220. If the password is not valid, the method does not proceed to this next step.

At block 220, a new session is set up in the user interface server 120 for the authoriser. This session is associated with the authoriser's username and with the web browser running on his computer terminal 170. It is envisaged that the session may be managed by recording information, perhaps by placing a “cookie”, in that web browser so that that information can be provided to the user server interface 120 with each interaction between the authoriser and the user server interface 120.

The method then progresses to block 225, wherein an authorisation policy 140 associated with the authoriser is retrieved. It is envisaged that a respective authorisation policy is stored in storage means of the application server 60, such as Random Access Memory or on a hard disk drive, for each user of the computer system and that the respective authorisation policy 140 for the authoriser is retrieved at block 225. However, if there is no specific authorisation policy stored for the authoriser, a stored generic policy is retrieved. In an alternative embodiment, only one authorisation policy may be stored, and this policy would be retrieved for all authorisers.

At block 230, the retrieved authorisation policy 140 is used. The authorisation policy is firstly used to determine the user or users whom the authoriser may authorise. The authorisation policy may also impose limitations on the authorisation of users by only allowing the authoriser to whom the policy relates to authorise certain users under certain circumstances, such as at certain times of day or when any prevailing security alert level in the computer system is at a certain level.

Information indicative of the user who is to be authorised is then received from the authoriser. This information is received by the authoriser typing in the first few characters of the username of the user who is to be authorised into a web page provided by the user interface server 120. This page is submitted by the authoriser and the method includes the step of receiving the page and then returning to the authoriser a list of users who may be authorised by the authoriser, based on the authorisation policy for that authoriser, and whose usernames begin with the submitted characters. The authoriser then selects from the list the user who is to be authorised.

At block 235, if the information received from the authoriser is indicative of a user whom may be authorised by the authoriser in accordance with the authorisation policy 140, the authoriser is requested to attest to certain facts surround the circumstances of his attempted authorisation. Examples of these facts are: whether or not the user to be authorised is present; whether or not the authoriser knows personally that user; whether or not that user made a request in person to the authoriser for authorisation; and the manner by which the authoriser identified that user. The authorisers attestations in response to these questions are recorded at block 235 for later retrieval if needed for the purposes of establishing the facts surrounding the attempted authorisation.

A reset policy 150 associated with the user who is to be authorised is then retrieved at block 240. The reset policy 150 contains information indicative of criteria that must be met if the authorisation is to be successful. In this embodiment, the criteria are used for assessing the attestations and the identity of the authoriser and of the user to be authorised to determine whether or not the attempted authorisation of the later by the former is allowable. A reset policy 150 for a user may take one of several forms.

A “never” reset policy never considers an authorisation as valid and so never allows a successful authorisation of that user to be made. Such a user would therefore most likely have to seek resetting of his password by way of a helpdesk. An “always” reset policy considers any attempted authorisation as valid and always allows resetting of the password of the user to whom that policy applies. Such a user is therefore unrestricted. A “standard” reset policy requires attestations to be provided before an authorisation can be considered valid, and requires at least two authorisations to be recorded against a user before the password of that user can be changed. It is envisaged that facts relating to the circumstances of the attempted authorisation may also be taken into account by the reset policy 150. For example the time of day of the attempt may be used in deciding whether to authorise access.

The authorisation policy 140 associated with the authoriser is again retrieved at this point and is used to impose a final check on the attempted authorisation. For example, the time of day may have progressed to a time at which authorisation is not permitted. If the authorisation policy 140 and the reset policy 150 determine that the attempted authorisation is proper, the method proceeds to the next step of block 245. In block 245, information indicative that a successful authorisation has been made is recorded against the user who is to be authorised. This information includes the name of the authoriser and the time of the successful authorisation. The information also includes a “time to live”, this being a time after which the successful authorisation is considered expired and no longer valid. The information may, in certain embodiments, also include information relating to the circumstances of the authorisation or relating to the attestations.

The steps of blocks 210 to 245 must be successfully completed, in this embodiment, in relation to at least two authorisers, such that at least two successful authorisation are recorded against the user who is to be authorised. Steps 210 to 245 are therefore repeated for a second user, using a second terminal, shown at 171 in FIG. 2.

It may, however, be necessary for more than two successful authorisations to be recorded against certain users or if made by certain users acting as authorisers. This will be determined by the authorisation policies 140 and reset policies 150 for those users. For example, if a successful authorisation by an authoriser is considered weak either because of the status that the authoriser is accorded in the stored authorisation policy 140 for that authoriser, or because of the circumstances surrounding the authorisation and as attested to by the authoriser, the reset policy 150 may require that three or more successful authorisations may have to be recorded against the user who is to be authorised. The reset policy 150 determines, at block 250, whether or not the number of recorded and unexpired (i.e. “live”) authorisations is sufficient. If the number is sufficient, the method proceeds to the step of block 255.

At block 255 the authentication system driver 130 communicates with the authentication server 50 such that the password of the user who has been authorised is reset to a new value. Resetting the password involves one of the authorisers being prompted, via the user interface server 120, for a new value of the authorised user's password. In this embodiment, this is achieved by the authoriser inputting a new password. This step is subject to a password policy 160 for the user who has been authorised. The password policy determines whether or not a replacement password inputted by an authoriser is acceptable. For example, a password policy may specify a minimum password length, a maximum password length, whether or not passwords that are contained in or derivable from a dictionary of common passwords are acceptable, a required mix of character classes (such as upper case, lower case, numerals, special characters and punctuation), whether or not a password similar to the user's username or real name is acceptable. It is envisaged that, in other embodiments, the authoriser may select one of several passwords offered by the method and presented by the user interface server 120. Alternatively, the method may be such that the authorised user's password is reset to a standard and widely-known password to be replaced when the authorised user next logs in. Where the authoriser has inputted a new password, he then communicates this in a secure manner to the authorised user, for example by telling that user in person.

Once the password has been reset, the method proceeds to the step of block 260 where the authorisations that were recorded against the user who has been authorised are considered to be expired. Block 260 marks the end of the method and the authorised user is then able to login to the computer system, for example using the third terminal shown at 172 in FIG. 2. In certain embodiments, it is envisaged that block 260 may include the recording of information indicative that the authorised user is at least temporarily suspended from being an authoriser. This information may be recorded in that user's authorisation policy 140 or reset policy 140 such that it may be used appropriately in the method.

Up to the point at which the authorised user's password is reset, resetting of the password may be prevented by the authorisation policy 140 or the reset policy 150. For example, the time of day may have progressed so as to be a time at which password resetting is not permitted by the reset policy 150.

The process depicted in FIG. 3 may be implemented on a single computer or be distributed across multiple computers on a network. The process may also be stored in a computer storage medium such as a compact disk or memory device.

1. A method of authorising a user, the method including the steps of:
a) computer means receiving authorisation information from at least two authorisers, that information being indicative that the user to is be authorised; and
b) the computer means responding to receipt of the authorisation information by emitting an authorisation signal that authorises the user.

2. A method according to claim 1, wherein step (b) includes the step of comparing the received authorisation information with stored authorisation information accessible by the computer means and that includes authorisation criteria, and providing the authorisation signal upon finding that the required authorisation information meet the authorisation criteria.

3. A method according to claim 1, wherein the method is for authorising a user to access a computer system by resetting the user's password for accessing the computer system, and wherein step (b) includes providing the authorisation signal such that either of the user's password is changed and the requirement for the user to give a password is at least temporarily removed.

4. A method according to claim 1, wherein the method is for authorising a user to access at least part of a computer system and the authorisation signal is provided to password changing means of the system.

5. A method according to claim 4, wherein the password changing means is arranged to communicate with authentication server means to change the password.

6. A method according to claim 1, wherein the authorisation information is received from remote computer means operable by at least one of the authorisers to provide the authorisation information.

7. A method according to claim 1, wherein the authorisation information is provided over a computer network.

8. A method according to claim 1, wherein the received authorisation information includes authoriser information indicative of information relating to the authoriser from whom that authorisation information is received.

9. A method according to claim 8, wherein the method is for authorising a user access at least part of a computer system and the authoriser information includes at least one of the authoriser's username, password and domain within the computer system.

10. A method according to claim 9, wherein the authoriser's password includes aspects of one or more of: biometrics; Public Key Infrastructure; use of a smart card.

11. A method according to claim 8, wherein step (a) is followed by the additional step of accessing stored authoriser information and comparing the received authoriser information therewith to establish whether or not the received authoriser information is acceptable, the authorisation signal only being provided if the received authoriser information is acceptable.

12. A method according to claim 11, wherein the stored authoriser information is indicative of authoriser criteria that must be satisfied in order for the authorisation signal to be provided, wherein the comparison is by establishing whether or not at least some of the received authoriser information meets the authoriser criteria.

13. A method according to claim 12, wherein the received authorisation information includes authorisee information indicative of information relating to the user who is to be authorised.

14. A method according to claim 13, wherein the stored authoriser information includes information indicative of who may be authorised by the authoriser and step (a) is followed by the step of accessing that information and comparing the received authorisee information therewith to establish whether or not the user who is to be authorised may be so authorised by the authoriser, the authorisation signal only being provided in the event that this is the case.

15. A method according to claim 1, wherein the received authorisation information includes attestation information indicative of the circumstances of and/or surrounding the authorisation.

16. A method according to claim 15, wherein the attestation information includes information indicative of, at least one of: whether or not the user who is to be authorised is present; whether or not that user is personally known to the authoriser; whether or not that user personally requested authorisation from the authoriser; the manner by which the authoriser identified the user when the request was made.

17. A method according to claim 1, wherein the method includes the step of storing at least some of the received authorisation information for later retrieval.

18. A method according to claim 1, wherein step (a) is followed by the further step of accessing stored authorisee information indicative of information relating to the user who is to be authorised, that information being indicative of authorisee criteria that must be satisfied in order for the authorisation signal to be provided.

19. A method according to claim 18, wherein the stored authorisee information is indicative at least one of: who may authorise the user; by how many authorisers the user must be authorised for the authorisation signal to be provided; the times of day at which the user may be authorised; the source address of the authoriser's session.

20. A method according to claim 18, wherein step (a) is followed by the step of comparing the received authorisation information with the stored authorisee information and establishing whether or not the criteria are satisfied, the authorisation signal only being provided in the event that this is the case.

21. A method according to claim 20, wherein if the criteria are satisfied, the method includes the step of recording that the user who is be authorised has been authorised by the respective authoriser.

22. A method according to claim 21, wherein the method then includes the step of repeating at least some of the previously-defined steps for another authoriser and optionally for one or more further authorisers, until the user has been authorised by at least the number of authorisers specified by the stored authorisee information, whereupon the authorisation signal is provided in step (b).

23. A computer program product comprising a machine-readable carrier carrying thereon a computer program including code portions which, when executed by a computer, cause that computer to carry out a method according to claim 1.

24. A record carrier having recorded thereon a computer program including code portions which, when executed by a computer, cause that computer to carry out a method according to claim 1.

25. A computer programmed to carry out a method according to claim 1.

26. A computer system having a plurality of users and arranged such that at least one user can be authorised to gain access to the system by two other users, who are authorisers, by the authorisers providing authorisation information to computer means of the system in accordance with a method according to any one of claim 1.

27. A method of authorising a user, the method including the steps of:
a) a computer receiving authorisation information from at least two authorisers, that information being indicative that the user to is be authorised; and
b) the computer responding to receipt of the authorisation information by emitting an authorisation signal that authorises the user;
wherein the received authorisation information includes authoriser information indicative of information relating to the authoriser from whom that authorisation information is received;
wherein step (a) is followed by the additional step of accessing stored authoriser information and comparing the received authoriser information therewith to establish whether or not the received authoriser information is acceptable, the authorisation signal only being provided if the received authoriser information is acceptable;
wherein the stored authoriser information is indicative of authoriser criteria that must be satisfied in order for the authorisation signal to be provided, wherein the comparison is by establishing whether or not at least some of the received authoriser information meets the authoriser criteria, and
wherein the received authorisation information includes authorisee information indicative of information relating to the user who is to be authorised.

28. A method of authorising a user, the method including the steps of:
a) a computer receiving authorisation information from at least two authorisers, that information being indicative that the user to is be authorised; and
b) the computer responding to receipt of the authorisation information by emitting an authorisation signal that authorises the user;
wherein step (a) is followed by the further step of accessing stored authorisee information indicative of information relating to the user who is to be authorised, that information being indicative of authorisee criteria that must be satisfied in order for the authorisation signal to be provided;
wherein the stored authorisee information is indicative at least one of: who may authorise the user; by how many authorisers the user must be authorised for the authorisation signal to be provided; the times of day at which the user may be authorised; the source address of the authoriser's session; and
wherein step (a) is followed by the step of comparing the received authorisation information with the stored authorisee information and establishing whether or not the criteria are satisfied, the authorisation signal only being provided in the event that this is the case.

29. A computer program product comprising a machine-readable carrier carrying thereon a computer program including code portions which, when executed by a computer, cause that computer to carry out a process of authorising a user, the computer program including the steps of:
a) receiving authorisation information from at least two authorisers, that information being indicative that the user to is be authorised; and
b) responding to receipt of the authorisation information by emitting an authorisation signal that authorises the user.

30. A record carrier having recorded thereon a computer program including code portions which, when executed by a computer, cause that computer to carry out a method of authorising a user, including the steps of:
a) receiving authorisation information at a computer from at least two authorisers, that information being indicative that the user to is be authorised; and
b) responding to receipt of the authorisation information at the computer by emitting an authorisation signal that authorises the user.

31. A computer programmed to carry out a process of authorising a user, the method including the steps of:
a) computer means receiving authorisation information from at least two authorisers, that information being indicative that the user to is be authorised; and
b) the computer means responding to receipt of the authorisation information by emitting an authorisation signal that authorises the user.

32. A computer system having a plurality of users and arranged such that at least one user can be authorised to gain access to the system by two other users, who are authorisers, by the authorisers providing authorisation information to the computer system, the system comprising:
a) an authorisation portion receiving authorisation information from at least two authorisers, that information being indicative that the user to is be authorised; and
b) a response portion responding to receipt of the authorisation information by emitting an authorisation signal that authorises the user.
